(19) United States
(12) Patent Application Publication
(10) Pub. No.: US 2016/0335717 A1
(43) Pub. Date: Nov. 17, 2016

(54) SYSTEMS AND METHODS FOR PROVIDING SUBSEQUENT PAYMENT OPTIONS FOR IDENTIFIED ELIGIBLE USERS

(71) Applicant: Facebook, Inc., Menlo Park, CA (US)

(72) Inventors: Aaron Patrick O'Brien, San Francisco, CA (US); Luis Medina, Menlo Park, CA (US); John Stephen Anderson, Portola Valley, CA (US); Pedro Chen, Sunnyvale, CA (US); Marius Mircea Lazer, Mountain View, CA (US)

(21) Appl. No.: 14/709,363

(22) Filed: May 11, 2015

(51) Int. Cl. G06Q 40/02; G06Q 20/24

(52) U.S. Cl. CPC G06Q 40/025; G06Q 20/24

(57) ABSTRACT

Systems, methods, and non-transitory computer-readable media can determine that a user has requested a service that involves payment. Information associated with the user can be analyzed. It can be determined, based on the information associated with the user, that the user is eligible for a subsequent payment option. The subsequent payment option can be provided to the user as a line of credit applicable toward payment for the service.

### FIELD OF THE INVENTION

The present technology relates to the field of online transactions. More particularly, the present technology relates to techniques for providing subsequent payment options for identified eligible users.

### BACKGROUND

Today, people often utilize computing devices (or systems) for a wide variety of purposes. Users can use their computing devices to, for example, interact with one another, create content, share information, and access information. In some instances, a user of a computing device (or system) can use the computing device to access, engage with, interact with, or utilize a social networking system. In one example, the social networking system can provide financial services, such as advertising services. In this example, a user can utilize his or her computing device to access the social networking system and run advertisements or perform other financial transactions via the social networking system.

In some cases, a significant number of new users attempt to utilize the financial services, such as the advertising services, every day. However, conventional approaches to providing such services generally require each new user to add a payment method in order to complete a service account sign-up process. As a result, in accordance with conventional approaches, many new users do not complete the service account sign-up process and thus fail to convert to adopting such services. Accordingly, these users can miss the opportunity to use such services provided by the social networking system. Moreover, the social networking system can lose potential customers and related revenue. Due to these and other reasons, conventional approaches can create challenges for or reduce the overall experience associated with providing financial services such as advertising services.

### SUMMARY

Various embodiments of the present disclosure can include systems, methods, and non-transitory computer readable media configured to determine that a user has requested a service that involves payment. Information associated with the user can be analyzed. It can be determined, based on the information associated with the user, that the user is eligible for a subsequent payment option. The subsequent payment option can be provided to the user as a line of credit applicable toward payment for the service.

In an embodiment, one or more limitations associated with activating the subsequent payment option can be specified to the user. It can be determined that the user has activated the subsequent payment option. It can be determined that the user has reached the one or more limitations. The service can be ceased for the user until the user has provided an amount of payment owed for the service.

In an embodiment, the one or more limitations can be associated with at least one of a maximum amount of time allowed for delaying payment for the service or a maximum amount of credit allowed to be applicable toward payment for the service.

In an embodiment, the one or more limitations can be dynamically generated based on the information associated with the user.

In an embodiment, determining that the user is eligible for the subsequent payment option can further comprise acquiring a risk score for the user. The risk score can be acquired from the information associated with the user. It can be determined that the risk score for the user is less than or equal to a specified maximum allowable risk level.

In an embodiment, determining that the user is eligible for the subsequent payment option can further comprise acquiring social graph data relating to the user. The social graph data can indicate a plurality of social features associated with the user and can be acquired from the information associated with the user. It can be determined, based on the plurality of social features, that the user is eligible for the subsequent payment option.

In an embodiment, determining that the user is eligible for the subsequent payment option can further comprise acquiring a list of existing users who have each previously requested the service. It can be determined, based on an identifier for the user, that the user is absent from the list of existing users. The identifier for the user can be included in the information associated with the user.

In an embodiment, determining that the user is eligible for the subsequent payment option can further comprise acquiring a specified plurality of whitelisted locations. It can be determined, based on location data for the user, that the user is located in one or more whitelisted locations out of the specified plurality of whitelisted locations. The location data for the user can be included in the information associated with the user.

In an embodiment, historical user data associated with a plurality of users who utilize the service can be acquired. A model can be developed using one or more machine learning processes applied to the historical user data. Determining that the user is eligible for the subsequent payment option can be based on the model.

In an embodiment, the service can include an advertising service provided by a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example subsequent payment module configured to facilitate providing subsequent payment options for identified eligible users, according to an embodiment of the present disclosure.

FIG. 2A illustrates an example eligibility determination module configured to facilitate providing subsequent payment options for identified eligible users, according to an embodiment of the present disclosure.

FIG. 2B illustrates an example option module configured to facilitate providing subsequent payment options for identified eligible users, according to an embodiment of the present disclosure.

FIG. 3 illustrates an example flowchart associated with providing subsequent payment options for identified eligible users, according to an embodiment of the present disclosure.

FIG. 4A illustrates an example interface associated with providing subsequent payment options for identified eligible users, according to an embodiment of the present disclosure.

FIG. 4B illustrates an example interface associated with providing subsequent payment options for identified eligible users, according to an embodiment of the present disclosure.

FIG. 5 illustrates an example method associated with providing subsequent payment options for identified eligible users, according to an embodiment of the present disclosure.

FIG. 6 illustrates an example method associated with providing subsequent payment options for identified eligible users, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Subsequent Payment Options for Identified Eligible Users

People use computing devices (or systems) for a wide variety of purposes. Computing devices can provide different kinds of functionality. Users can utilize their computing devices to produce information, access information, and share information. In some cases, users of computing devices (or systems) can engage or interact with social networking systems. In some instances, users can use their computing devices to access, operate, or otherwise utilize financial or other services that involve payment, such as advertising services. For example, using his or her computing device, a user can access and employ an advertisement service provided by a social networking system. In this example, the user can use the advertisement service to develop, run, and manage one or more advertisements to be distributed via the social networking system.

It is becoming increasing commonplace for users to use their computing devices to access, implement, or otherwise utilize services that involve payment or other financial transactions, such as advertising services. Every day, a large number of people may attempt to sign up or register as new users of these services. Under conventional approaches to providing such services, new users generally have to provide a payment method in order to complete the sign-up or registration process. However, users may often times be reluctant to provide their payment methods, in accordance with conventional approaches. This can be due to a wide variety of reasons. For instance, users may be anxious and thus fail to supply their payment methods, or users may feel that providing their payment methods is too time-consuming or inconvenient at the moment. As a result, many new users fail to convert and adopt to these financial or other services that involve payment, thereby missing out on the benefits and advantages of such services. It also follows that the service providers, such as the social networking system, lose potential customers and related revenue.

Due to these or other concerns, conventional approaches can be inconvenient, inefficient, or impractical. Therefore, an improved approach can be beneficial for addressing or alleviating various drawbacks associated with conventional approaches. The disclosed technology can provide subsequent payment options for identified eligible users. Various embodiments of the present disclosure can determine that a user has requested a service that involves payment. Information associated with the user can be analyzed. It can be determined, based on the information associated with the user, that the user is eligible for a subsequent payment option. The subsequent payment option can be provided to the user as a line of credit applicable toward payment for the service. It is contemplated that there can be many variations and/or other possibilities.

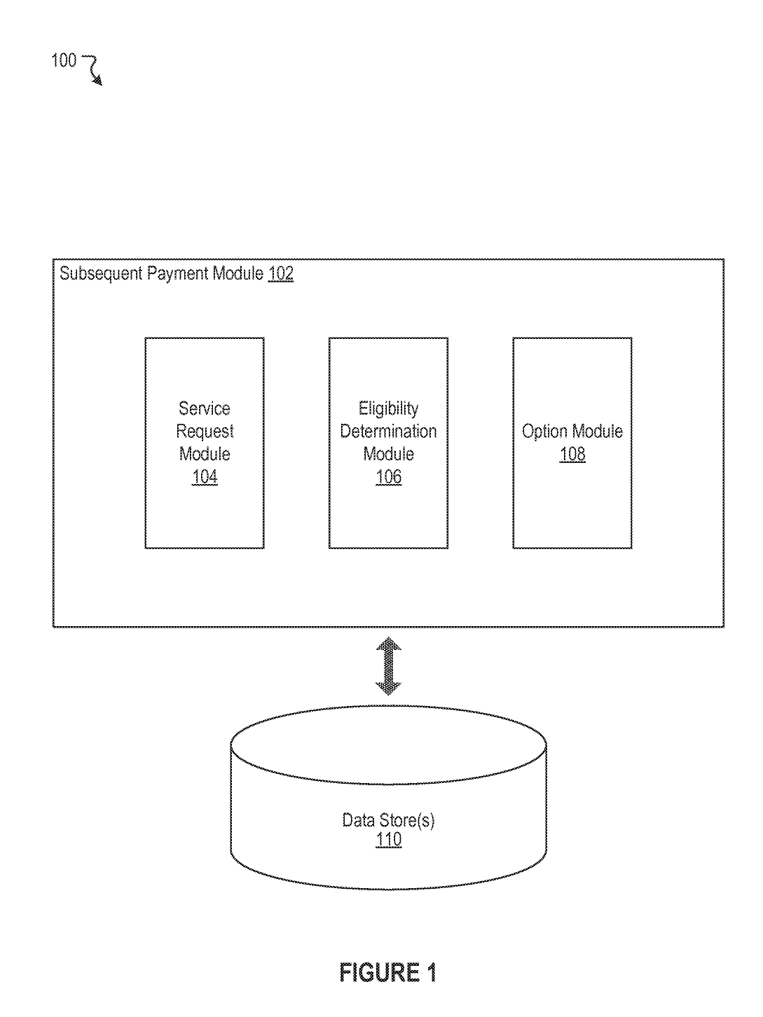

FIG. 1 illustrates an example system 100 including an example subsequent payment module 102 configured to facilitate providing subsequent payment options for identified eligible users, according to an embodiment of the present disclosure. As shown in the example of FIG. 1, the subsequent payment module 102 can include a service request module 104, an eligibility determination module 106, and an option module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

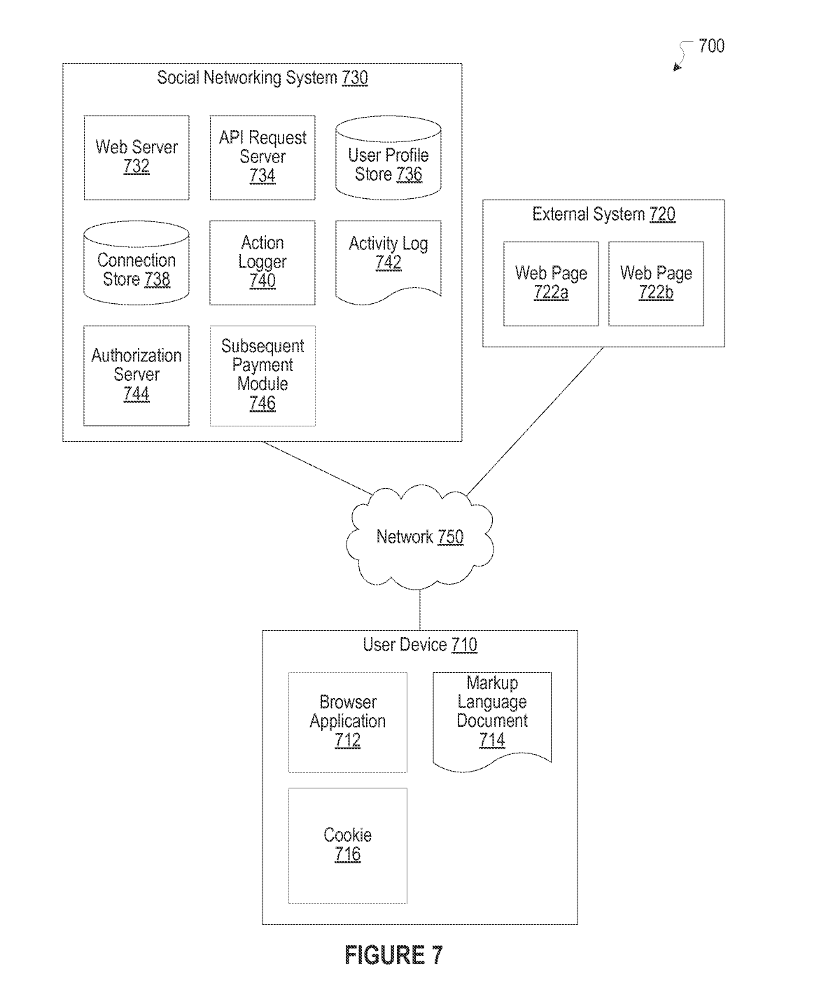

In some embodiments, the subsequent payment module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the subsequent payment module 102 can be implemented, in part or in whole, as software running on one or more computing devices or systems, such as on a user or client computing device. For example, the subsequent payment module 102 or at least a portion thereof can be implemented as or within an application (e.g., app), a program, or an applet, etc., running on a user computing device or a client computing system, such as the user device 710 of FIG. 7. In another example, the subsequent payment module 102 or at least a portion thereof can be implemented using one or more computing devices or systems that include one or more servers, such as network servers or cloud servers. In some instances, the subsequent payment module 102 can, in part or in whole, be implemented within or configured to operate in conjunction with a social networking system (or service), such as the social networking system 730 of FIG. 7. It should be understood that there can be many variations or other possibilities.

The service request module 104 can be configured to facilitate determining that a user has requested a service that involves payment (or other financial transactions). In some cases, the service request module 104 can determine that the user has manually requested the service that involves payment, such as an advertising service that provides advertisement distribution in exchange for payment. In one example, the service request module 104 can determine that the user has navigated to a landing page or other interface associated with the service (e.g., the advertising service). In this example, the advertising service can be provided by the social networking system and thus the landing page or other interface can correspond to a page or resource within the social networking system. If the user so chooses, he or she can elect to proceed with trying to use the advertising service. In this example, the user can request the advertising service by clicking on, tapping on, or otherwise interacting with an interface element (e.g., a button), which can initiate a sign-up or registration process for the advertising service. The service request module 104 can, for instance, detect that the interface element has been interacted with by the user and thus can determine that the user has requested the service. It is contemplated that all examples herein are provided for illustrative purposes and that there can be many variations or other possibilities.

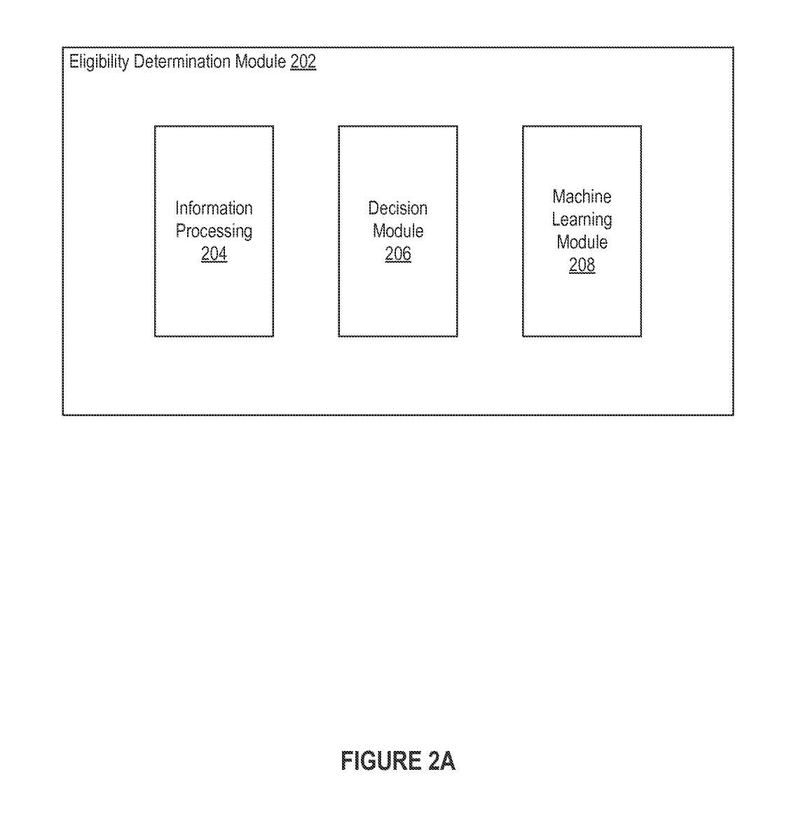

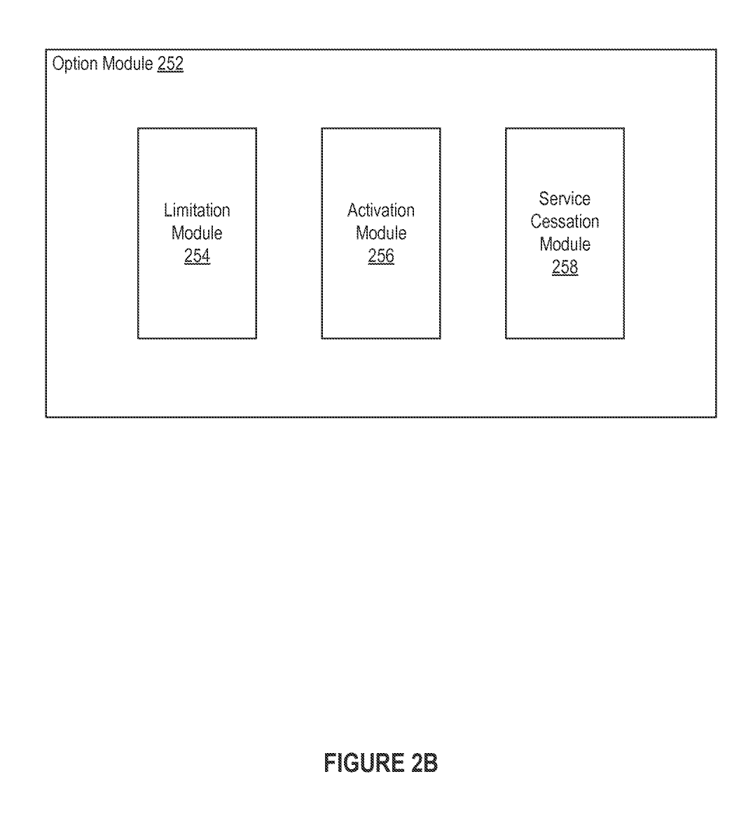

Moreover, the eligibility determination module 106 can be configured to facilitate acquiring and analyzing information associated with the user. The eligibility determination module 106 can be further configured to facilitate determining, based on (i.e., based at least in part on) the information associated with the user, that the user is eligible for a subsequent payment option. The eligibility determination module 106 can, for example, identify the user as being eligible for the subsequent payment option based on the information associated with the user. In some instances, the disclosed technology can determine whether or not the user is eligible for the subsequent payment option even when the information is limited or nonexistent with respect to financial/credit details of the user. More details regarding the eligibility determination module 106 will be provided below with reference to FIG. 2A.

In addition, the option module 108 can be configured to facilitate providing the subsequent payment option to the user as a line of credit applicable toward payment for the service. For instance, the option module 108 can provide the subsequent payment option to the user when it has been determined that the user is eligible. The option module 108 will be discussed in more detail with reference to FIG. 2B.

Furthermore, in some embodiments, the subsequent payment module 102 can be configured to communicate and/or operate with the at least one data store 110, as shown in the example system 100. The at least one data store 110 can be configured to store and maintain various types of data. In some implementations, the at least one data store 110 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user locations, user specified settings, content produced or posted by users, and various other types of user data. In some embodiments, the at least one data store 110 can store information that is utilized by the subsequent payment module 102. It is contemplated that there can be many variations or other possibilities.

FIG. 2A illustrates an example eligibility determination module 202 configured to facilitate providing subsequent payment options for identified eligible users, according to an embodiment of the present disclosure. In some embodiments, the eligibility determination module 106 of FIG. 1 can be implemented as the example eligibility determination module 202. As shown in FIG. 2A, the eligibility determination module 202 can include an information processing module 204, a decision module 206, and a machine learning module 208.

In some embodiments, the eligibility determination module 202 can utilize the information processing module 204 to facilitate analyzing information associated with a user who has requested a service that involves payment, such as an advertising service provided by a social networking system. The information processing module 204 can be configured to acquire and analyze various types of information associated with user, which can include, but is not limited to, risk data, social graph data, identification data, location data, historical data (e.g., past activity, recent activity, etc.), and so forth. In some instances, the information processing module 204 can acquire an identifier for the user, such as a user identification number or a user name, when the user makes the request for the service. Based on (i.e., based at least in part on) the identifier for the user, the information processing module 204 can then query the social networking system and/or various other sources, such as third-party sources, for the information associated with the user. Again, it should be appreciated that many variations are possible.

Additionally, in some embodiments, the eligibility determination module 202 can utilize the decision module 206 to facilitate determining, based on the information associated with the user, that the user is eligible for a subsequent payment option, which can then be provided to the user as a line of credit applicable toward payment for the service. In one example, the decision module 206 can determine that the user is eligible for the subsequent payment option based on acquiring a risk score for the user. The risk score can be acquired from the information associated with the user. In some instances, the social networking system can generate a respective risk score (e.g., a site integrity fake index score, a fake account index, etc.) for every user of the social networking network. Users (i.e., user accounts) associated with a lower risk score can more likely correspond to a real and/or legitimate user of the social networking system, whereas users associated with a higher risk score can more likely correspond to a fake, fraudulent, and/or illegitimate user. In some cases, the risk score can correspond to a trust level or score, which can be determined for the user based on interactions between the user and other users (e.g., friends or social connections of the user). Continuing with this example, the decision module 206 can determine that the risk score for the user is less than or equal to a specified maximum allowable risk level. Accordingly, the decision module 206 can consider, recognize, and/or deem the user as being eligible, or at least partially eligible, for the subsequent payment option. For instance, the decision module 206 can set or specify the maximum allowable risk level to correspond to a risk score of 0.3 out of 1.0, such that users who have risk scores higher than 0.3 are ineligible for the subsequent payment option.

In another example, the decision module 206 can determine that the user is eligible for the subsequent payment option based on acquiring social graph data relating to the user. The social graph data can indicate a plurality of social features associated with the user and can be acquired from the information associated with the user. The decision module 206 can determine, based on the plurality of social features, that the user is eligible for the subsequent payment option. For instance, the decision module 206 can determine that the user is (at least partially) eligible if a social feature indicates that the user's social networking system account has been active for at least a minimum amount of time and/or if another social feature indicates that the user has at least a minimum number of friends or social connections.

In a further example, the decision module 206 can determine that the user is eligible for the subsequent payment option based on acquiring a list of existing users who have each previously requested the service. The decision module 206 can determine, based on an identifier for the user, that the user is absent from the list of existing users. The identifier for the user can be included in the information associated with the user. For instance, the decision module 206 can determine that the user is (at least partially) eligible if the user is a new user not having previously requested for the service.

Moreover, in another example, the decision module 206 can determine that the user is eligible for the subsequent payment option based on acquiring a specified plurality of whitelisted locations. The decision module 206 can determine, based on location data for the user, that the user is located in one or more whitelisted locations out of the specified plurality of whitelisted locations. The location data for the user can be included in the information associated with the user. For instance, the specified plurality of whitelisted locations can include countries, territories, or regions that have been determined or defined to have lower likelihoods of being associated with illegitimate users, fraudulent users, etc.

Furthermore, in some implementations, the eligibility determination module 202 can utilize the machine learning module 208 to facilitate acquiring historical user data associated with a plurality of users who utilize the service. The machine learning module 208 can develop a model using one or more machine learning processes applied to the historical user data. In some cases, determining that the user is eligible for the subsequent payment option can be based on the model. As such, in some instances, the model can replace one or more of the above approaches to determining subsequent payment eligibility (e.g., based on risk data, social graph data, identification data, and/or location data, etc.). In some embodiments, the model can enable the disclosed technology to learn, to improve, to be back-tested, and/or to be refined over time. It should be appreciated that all examples herein are provided for illustrative purposes and that there can be many variations or other possibilities.

FIG. 2B illustrates an example option module 252 configured to facilitate providing subsequent payment options for identified eligible users, according to an embodiment of the present disclosure. In some embodiments, the option module 108 of FIG. 1 can be implemented as the example option module 252. As shown in FIG. 2B, the option module 252 can include a limitation module 254, an activation module 256, and a service cessation module 258.

As discussed above, the option module 252 can be configured to facilitate providing a subsequent payment option to a user as a line of credit applicable toward payment for a service requested by the user. The option module 252 can, for instance, provide the subsequent payment option to the user upon or after determining that the user is eligible for the subsequent payment option. In some cases, the option module 252 can allow eligible users to add a payment method later and to proceed with utilizing the service, but can require ineligible users to add a payment method before such ineligible users can utilize the service.

Furthermore, in some embodiments, the option module 252 can utilize the limitation module 254 to specify, to the user requesting the service, one or more limitations associated with activating the subsequent payment option. For instance, the limitation module 254 can specify or provide the one or more limitations to the user such that the user has an opportunity to view, read, and understand the limitations before selecting, accepting, and/or activating the subsequent payment option. The limitation module 254 can also be configured to determine that the user has reached the one or more limitations. In some cases, the one or more limitations can be associated with at least one of a maximum amount of time allowed for delaying payment for the service or a maximum amount of credit allowed to be applicable toward payment for the service.

Moreover, in some implementations, the option module 252 can utilize the activation module 256 to determine that the user has activated the subsequent payment option. For instance, when the subsequent payment option is provided to the user, the activation module 256 can detect that the user has selected, accepted, and/or activated the subsequent payment option, which can enable the user to continue using the service without having to add a payment method at the moment.

Additionally, in some embodiments, the option module 252 can utilize the service cessation module 258 to cease the service for the user until the user has provided an amount of payment owed for the service. For instance, the service cessation module 258 can suspend, stop, terminate, or otherwise cease the service if the one or more limitations are reached by the user and the user has not paid for the service.

In one example, the limitation module 254 can specify to the user that he or she can utilize an advertising service, without initially paying, for up to three days and up to a cost of $25, whichever limitation is met first. In this example, the activation module 256 can determine that the user has selected or activated the subsequent payment option. The limitation module 254 can thus monitor and detect when the user has run advertisements via the advertising service for the three days and/or when the $25 line of credit has been completely used by the user for running the advertisements. The user must then add a payment method and pay the amount he or she owes for using the advertising service. If the user does not pay the amount, the service cessation module 258 can cease the advertising service for the user. In this way, the line of credit can, for instance, be distinguishable from a coupon or a gifted monetary amount.

Furthermore, in some implementations, the limitation module 254 can be configured to facilitate dynamically generating the one or more limitations based on the information associated with the user. As such, the one or more limitations can be tailored, personalized, and/or customized for each user who requests the service. For instance, a more credible or trustworthy user can have higher limitations (e.g., a longer amount of time and/or a larger line of credit). Again, it should be understood that all examples herein are provided for illustrative purposes and that many variations are possible.

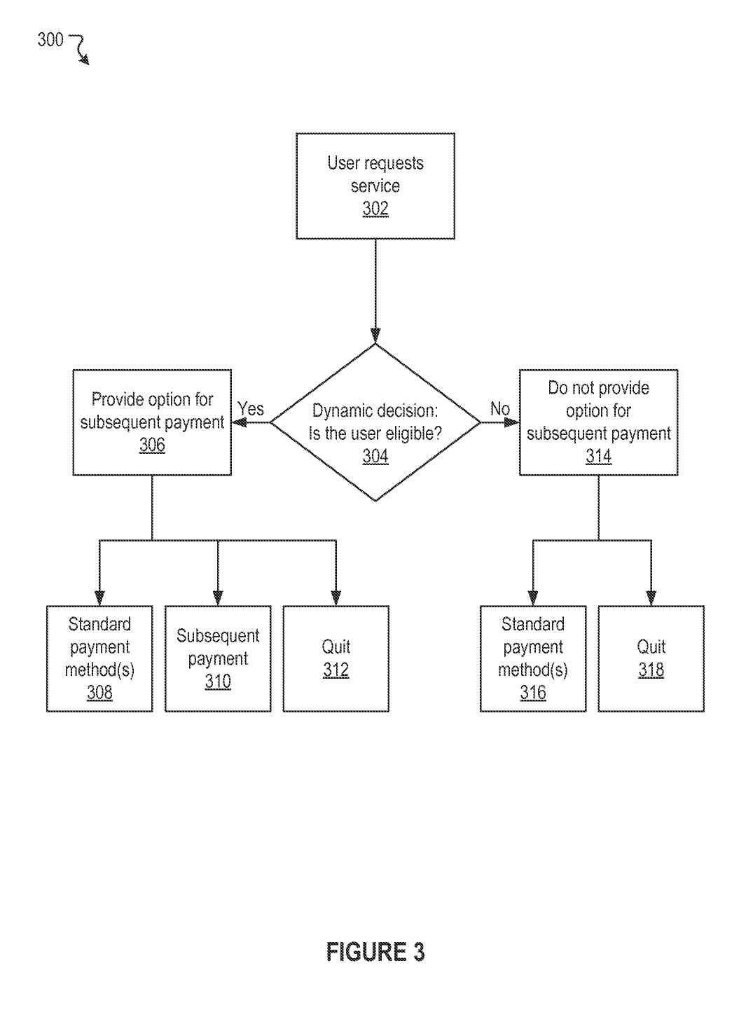

FIG. 3 illustrates an example flowchart 300 associated with providing subsequent payment options for identified eligible users, according to an embodiment of the present disclosure. At block 302 of the example flowchart 300, a user can request a service that involves payment, such as an advertising service provided by a social networking system. At block 304, a dynamic decision or determination can be made with regard to whether or not the user is eligible for a subsequent payment option. If the user is dynamically determined or identified as being eligible, then at block 306, the subsequent payment option can be provided to the user. Accordingly, in this case, the user can have three options. At block 308, the user can choose to add one or more payment methods, such as standard payment methods (e.g., credit cards, debit accounts, online payment services, etc.). At block 310, the user can decide not to add payment methods at the moment and instead choose the subsequent payment option to delay payment for the service. At block 312, the user can decide to quit, instead of adding any payment methods or selecting the subsequent payment option.

If, however, the user is dynamically determined to be ineligible, then at block 314, the subsequent payment option is not provided to the user. Accordingly, in this case, the user can have only two options. At block 316, the user can choose to add one or more payment methods, such as standard payment methods, if the user still desires to proceed with using the service. At block 318, the user can decide to quit, instead of adding any payment methods. It should be appreciated that many variations are possible.

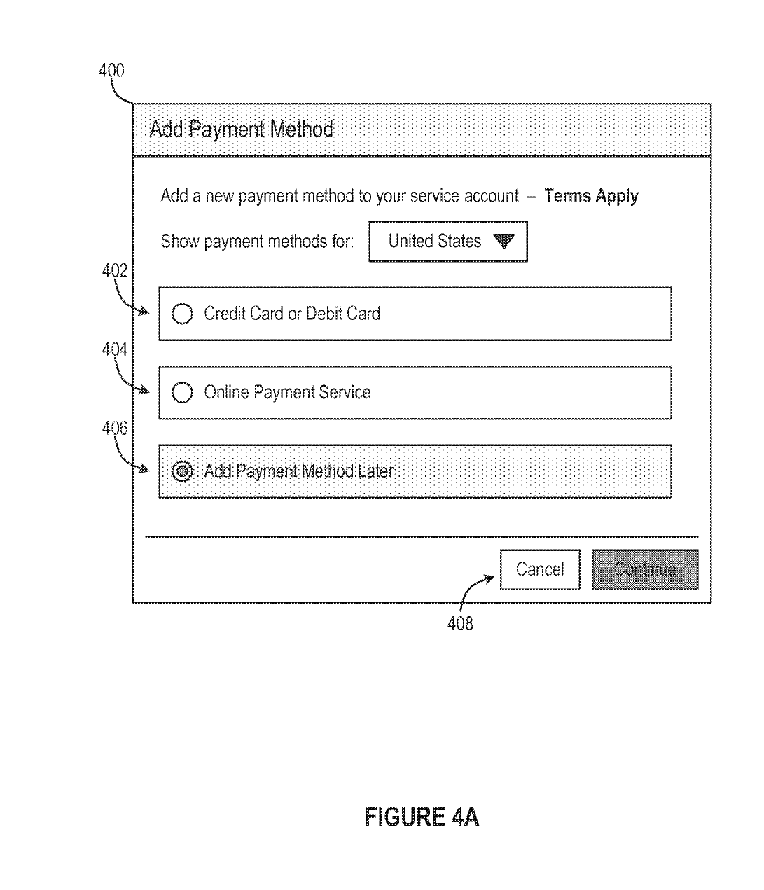

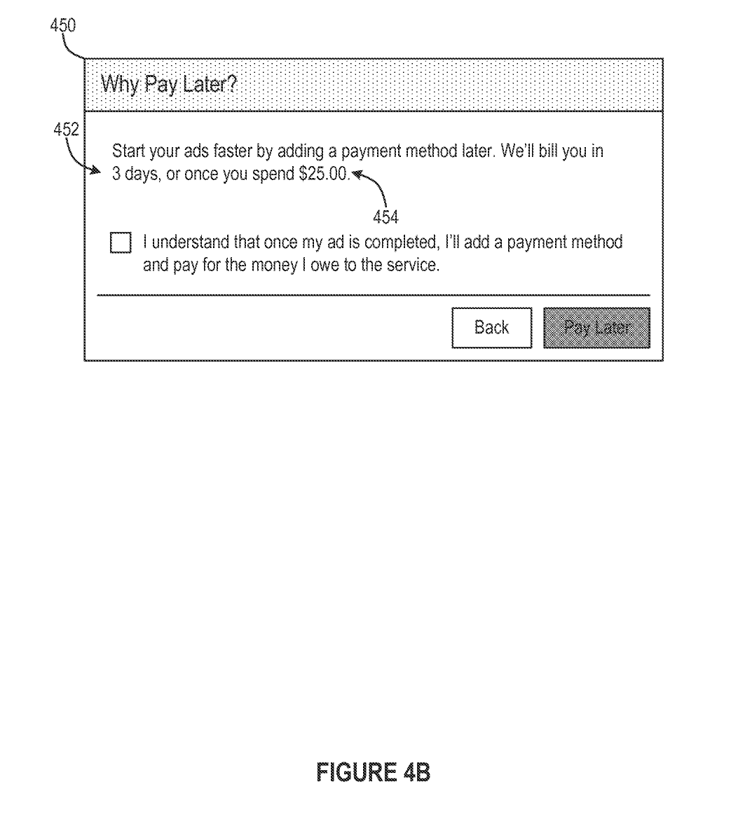

FIG. 4A illustrates an example interface (or interface portion) 400 associated with providing subsequent payment options for identified eligible users, according to an embodiment of the present disclosure. The example interface 400 can be part of a sign-up, registration, or set-up process for using an advertising service provided by a social networking system. In the example of FIG. 4A, a user has been determined or identified as being eligible for a subsequent payment option. When the user is presented with example interface 400, the user can choose to add one or more standard payment methods, such as credit/debit cards 402 or online payment services 404. Moreover, since the user has been determined to be eligible, the interface 400 can also provide to the user the subsequent payment option (e.g., “Add Payment Method Later”) 406. Furthermore, the user can also have an option to quit 308 or not use the service. In this example, the user has selected the subsequent payment option 406. There can be many variations or other possibilities.

FIG. 4B illustrates an example interface (or interface portion) 450 associated with providing subsequent payment options for identified eligible users, according to an embodiment of the present disclosure. The example interface 450 can provide an explanation or description for the subsequent payment option. Moreover, the example interface 450 can provide or specify to the user one or more limitations associated with activating the subsequent payment option. In this example, the one or more limitations can be associated with at least one of a maximum amount of time (e.g., 3 days) 452 allowed for delaying payment for the service or a maximum amount of credit (e.g., $25.00) 454 allowed to be applicable toward payment for the service. Again, many variations are possible.

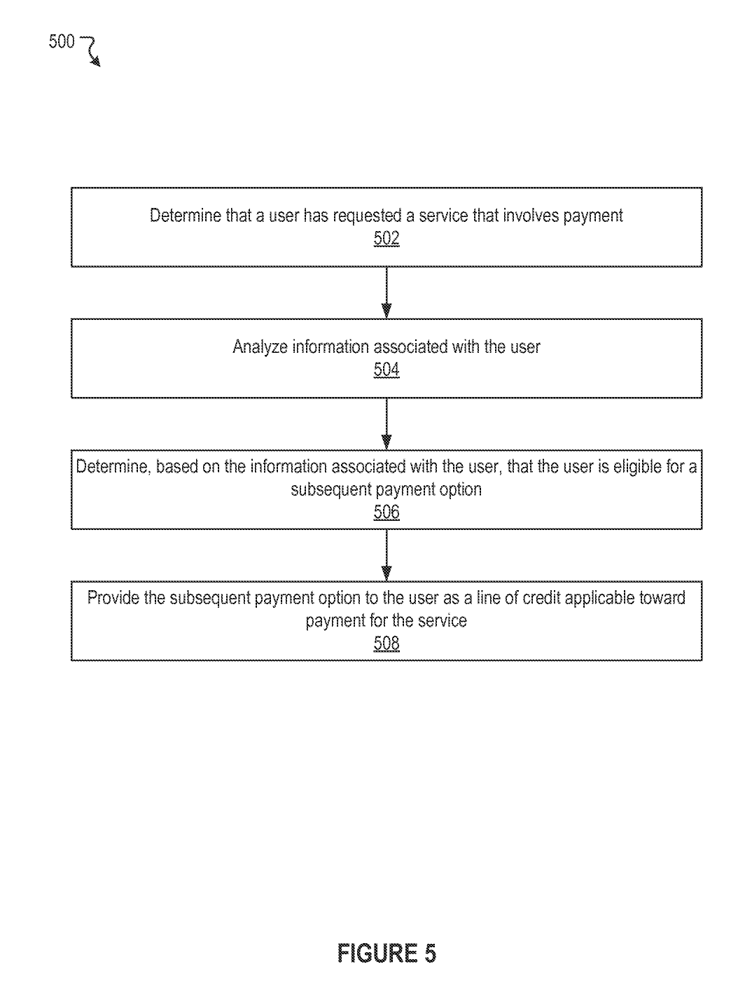

FIG. 5 illustrates an example method 500 associated with providing subsequent payment options for identified eligible users, according to an embodiment of the present disclosure. It should be appreciated that there can be additional, fewer, or alternative steps performed in similar or alternative orders, or in parallel, within the scope of the various embodiments unless otherwise stated.

At block 502, the example method 500 can determine that a user has requested a service that involves payment. At block 504, the example method 500 can analyze information associated with the user. At block 506, the example method 500 can determine, based on the information associated with the user, that the user is eligible for a subsequent payment option. At block 508, the example method 500 can provide the subsequent payment option to the user as a line of credit applicable toward payment for the service.

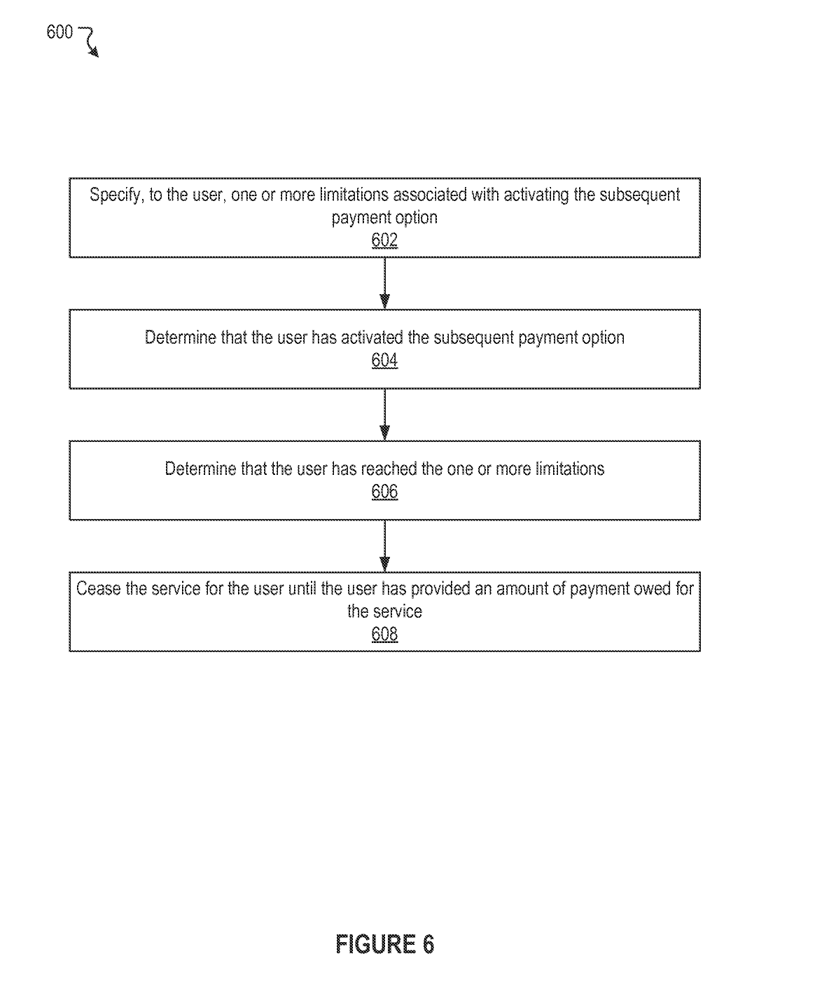

FIG. 6 illustrates an example method 600 associated with providing subsequent payment options for identified eligible users, according to an embodiment of the present disclosure. Again, it should be appreciated that there can be additional, fewer, or alternative steps performed in similar or alternative orders, or in parallel, within the scope of the various embodiments unless otherwise stated.

At block 602, the example method 600 can specify, to the user, one or more limitations associated with activating the subsequent payment option. At block 604, the example method 600 can determine that the user has activated the subsequent payment option. At block 606, the example method 600 can determine that the user has reached the one or more limitations. At block 608, the example method 600 can cease the service for the user until the user has provided an amount of payment owed for the service.

In some embodiments, one or more reminders, such as reminders to add a payment method and/or to pay any amount owed for using the service, can be provided to the user before the user has reached the one or more limitations. In some implementations, one or more options to add a payment method can be provided to the user before the user has reached the one or more limitations. Moreover, as discussed above, in some instances, the disclosed technology can determine whether or not the user is eligible for the subsequent payment option even when information is limited or nonexistent with respect to financial/credit details of the user. In some cases, however, when financial/credit information of the user is available, the disclosed technology can utilize (i.e., utilize at least in part) such information to determine whether or not the user is eligible for the subsequent payment option. In some instances, the disclosed technology can also utilize various social networking system features, properties, and/or information associated with the user, such as by analyzing the credit worthiness or eligibility of the user's friends and/or family to facilitate determining the user's eligibility for the subsequent payment option. Furthermore, in some cases, various embodiments of the disclosed technology can be utilized with or applicable toward peer-to-peer (P2P) finances (e.g., P2P payments, P2P lending, P2P funding, etc.), gaming (e.g., social gaming), and/or commerce (e.g., group commerce).

It is contemplated that there can be many other uses, applications, features, possibilities, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a subsequent payment module 746. The subsequent payment module 746 can, for example, be implemented as the subsequent payment module 102 of FIG. 1. As discussed previously, it should be appreciated that there can be many variations or other possibilities. For example, in some instances, the subsequent payment module 746 (or at least a portion thereof) can be included in the user device 710. Other features of the subsequent payment module 746 are discussed herein in connection with the subsequent payment module 102.

### Hardware Implementation

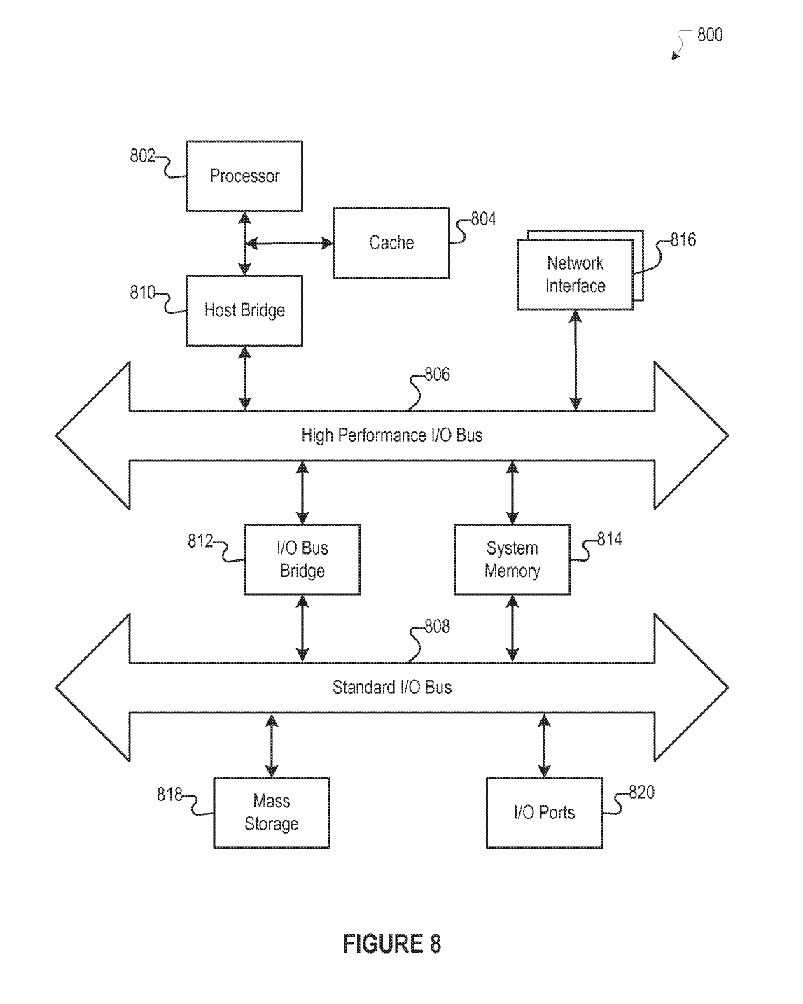

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, that a user has requested a service that involves payment;
analyzing, by the computing system, information associated with the user;
determining, by the computing system, based on the information associated with the user, that the user is eligible for a subsequent payment option; and
providing, by the computing system, the subsequent payment option to the user as a line of credit applicable toward payment for the service.

2. The computer-implemented method of claim 1, further comprising:
specifying, to the user, one or more limitations associated with activating the subsequent payment option;
determining that the user has activated the subsequent payment option;
determining that the user has reached the one or more limitations; and
ceasing the service for the user until the user has provided an amount of payment owed for the service.

3. The computer-implemented method of claim 2, wherein the one or more limitations are associated with at least one of a maximum amount of time allowed for delaying payment for the service or a maximum amount of credit allowed to be applicable toward payment for the service.

4. The computer-implemented method of claim 2, wherein the one or more limitations are dynamically generated based on the information associated with the user.

5. The computer-implemented method of claim 1, wherein determining that the user is eligible for the subsequent payment option further comprises:
acquiring a risk score for the user, the risk score being acquired from the information associated with the user; and
determining that the risk score for the user is less than or equal to a specified maximum allowable risk level.

6. The computer-implemented method of claim 1, wherein determining that the user is eligible for the subsequent payment option further comprises:
acquiring social graph data relating to the user, the social graph data indicating a plurality of social features associated with the user and being acquired from the information associated with the user; and
determining, based on the plurality of social features, that the user is eligible for the subsequent payment option.

7. The computer-implemented method of claim 1, determining that the user is eligible for the subsequent payment option further comprises:
acquiring a list of existing users who have each previously requested the service; and
determining, based on an identifier for the user, that the user is absent from the list of existing users, the identifier for the user being included in the information associated with the user.

8. The computer-implemented method of claim 1, determining that the user is eligible for the subsequent payment option further comprises:
acquiring a specified plurality of whitelisted locations; and
determining, based on location data for the user, that the user is located in one or more whitelisted locations out of the specified plurality of whitelisted locations, the location data for the user being included in the information associated with the user.

9. The computer-implemented method of claim 1, further comprising:
acquiring historical user data associated with a plurality of users who utilize the service; and
developing a model using one or more machine learning processes applied to the historical user data, wherein determining that the user is eligible for the subsequent payment option is based on the model.

10. The computer-implemented method of claim 1, wherein the service includes an advertising service provided by a social networking system.

11. A system comprising:
at least one processor; and
a memory storing instructions that, when executed by the at least one processor, cause the system to perform:
determining that a user has requested a service that involves payment;
analyzing information associated with the user;
determining, based on the information associated with the user, that the user is eligible for a subsequent payment option; and
providing the subsequent payment option to the user as a line of credit applicable toward payment for the service.

12. The system of claim 11, wherein the instructions cause the system to further perform:
specifying, to the user, one or more limitations associated with activating the subsequent payment option;
determining that the user has activated the subsequent payment option;
determining that the user has reached the one or more limitations; and
ceasing the service for the user until the user has provided an amount of payment owed for the service.

13. The system of claim 12, wherein the one or more limitations are associated with at least one of a maximum amount of time allowed for delaying payment for the service or a maximum amount of credit allowed to be applicable toward payment for the service.

14. The system of claim 12, wherein the one or more limitations are dynamically generated based on the information associated with the user.

15. The system of claim 11, wherein determining that the user is eligible for the subsequent payment option further comprises:
acquiring a risk score for the user, the risk score being acquired from the information associated with the user; and
determining that the risk score for the user is less than or equal to a specified maximum allowable risk level.

16. A non-transitory computer-readable storage medium including instructions that, when executed by at least one processor of a computing system, cause the computing system to perform:
determining that a user has requested a service that involves payment;
analyzing information associated with the user;
determining, based on the information associated with the user, that the user is eligible for a subsequent payment option; and
providing the subsequent payment option to the user as a line of credit applicable toward payment for the service.

17. The non-transitory computer-readable storage medium of claim 16, wherein the instructions cause the system to further perform:
specifying, to the user, one or more limitations associated with activating the subsequent payment option;
determining that the user has activated the subsequent payment option;
determining that the user has reached the one or more limitations; and
ceasing the service for the user until the user has provided an amount of payment owed for the service.

18. The non-transitory computer-readable storage medium of claim 17, wherein the one or more limitations are associated with at least one of a maximum amount of time allowed for delaying payment for the service or a maximum amount of credit allowed to be applicable toward payment for the service.

19. The non-transitory computer-readable storage medium of claim 17, wherein the one or more limitations are dynamically generated based on the information associated with the user.

20. The non-transitory computer-readable storage medium of claim 16, wherein the instructions cause the system to further perform:
acquiring a risk score for the user, the risk score being acquired from the information associated with the user; and
determining that the risk score for the user is less than or equal to a specified maximum allowable risk level.
